(19) United States
(12) Patent Application Publication
(10) Pub. No.: US 2004/0235636 A1
(43) Pub. Date: Nov. 25, 2004

(54) Compositions of a glass substrate

(75) Inventors: Hsien-Yin Tsai, Hsin Ying City (TW); Chien-Sheng Yeh, Taipei (TW)

Correspondence Address: BRUCE H. TROXELL, SUITE 1404, 5205 LEESBURG PIKE, FALLS CHURCH, VA, 22041, US

(73) Assignee: Picvue Optoelectronics International, Inc.

(21) Appl. No.: 10/745,603

(22) Filed: Dec. 29, 2003

(30) Foreign Application Priority Data
May 24, 2003 (TW) 92113965

(51) Int. Cl. C03C 3/095; C03C 3/091

(52) U.S. Cl. 501/64; 501/66

(57) ABSTRACT

Compositions for producing a glass substrate comprise SiO₂ with a weight percentage (wt %) from 55% to 70%, Al₂O₃ from 10 wt % to 18 wt %, B₂O₃ from 10 wt % to 15 wt %, CaO from 0 wt % to 10 wt %, SrO from 0 wt % to 4 wt %, and a particular composition for forming a network structure of SiO₂ from 0.01 wt % to 10 wt %, in which the particular composition can be selected from a group consisting of Y₂O₃ and La₂O₃.

### FIELD OF THE INVENTION

The present invention relates to a plurality of compositions of a glass substrate, and more particularly to the compositions of a large-area glass substrate used for plate panel display.

### BACKGROUND OF THE INVENTION

The plate panel display becomes more and more important in displaying multimedia information to people in these years. Various kinds of the electric devices, such as notebooks, mobile phones, etc., all need plate panel displays. Typically, the plate panel display for displaying multimedia consists of a glass substrate and other components.

As a trend of minimizing sizes of electronic devices, the glass substrate for the plate panel display is also made more and more thinner. In order to cost down, to produce the large-area glass substrate becomes necessary. Though current universal standard of the glass substrate is set upon the 3'th generation (550 mm*650 mm) or the 3.5'th generation (600 mm*720 mm), yet the 5'th generation (1100 mm*1250 mm) becomes even popular and will soon be the mainstream in a foreseen future. So, to produce a thin and large-area glass substrate has become one of the technology trends in multimedia industry.

In order to provide a quality low-cost glass substrate production, 5 important points as follows need to be considered. First of all is the strain point temperature. To achieve a better thermal stability in production, the strain point temperature should be no lower than 600° C.; in particular, higher than 650° C. Secondly, a lower coefficient of thermal expansion is needed, which can reduce the deformation of glass substrate in production and thus make easier to embed the chip on the glass substrate. Thirdly, a higher chemical resistance is required, by which the glass substrate can then be comfortable in an etching environment. Fourthly, a highly Young's modulus to present the rigidity of the glass substrate is also needed to avoid possible deformation caused by unexpected forcing. Finally, the technique to decrease the surface roughness is also important in improving the display quality.

In U.S. Pat. No. 5,116,787 and U.S. Pat. No. 5,116,789, the glass substrate has a highly strain point temperature and an unexpected high thermal expansion coefficient, which will cause the glass substrate to deform severely while the surrounding temperature is changed. Though the thermal expansion problem can be overcome by a non-alkali glass substrate disclosed in U.S. Pat. No. 5,116,787 or U.S. Pat. No. 5,116,789, yet the Young's modulus is still waited to be raised.

Therefore, the object of this invention is targeted to provide a plurality of compositions of the glass substrate in solving the problem mentioned above.

### SUMMARY OF THE INVENTION

It is an object of the invention to provide a plurality of compositions of a glass substrate, for producing the glass substrate with a satisfied Young's modulus.

It is another object of this invention to provide compositions of a glass substrate which can provide a lower thermal expansion coefficient.

It is one more object of this invention to provide compositions in producing a glass substrate with a higher strain point temperature and a higher annealing point temperature.

A further object of this invention is to produce a glass substrate having a smoother surface.

Another further object of this invention is to produce a chemical-resistance glass substrate.

According to the present invention, the compositions of the glass substrate comprises SiO₂ by a weight percentage (wt %) from 55% to 70% of the glass substrate, Al₂O₃ from 10 wt % to 18 wt %, B₂O₃ from 10 wt % to 15 wt %, CaO from 0 wt % to 10 wt %, and SrO from 0 wt % to 4 wt %. The compositions can further be integrated to form a network structure of SiO₂ by adding a material selected from the group consisting of Y₂O₃ and La₂O₃ by a weight percentage ranged from 0.01% to 10% of the glass substrate.

In the present invention, the Young's modulus of the glass substrate can be greater than 7200 kg/mm², the strain point temperature can be higher than 650° C., the annealing point temperature can be higher than 700° C., and the coefficient of thermal expansion can be lower to 31×10⁻⁷. Meanwhile, the surface roughness of the glass substrate can be smaller than 0.5 nm. Regarding the chemical resistance, the weight loss can be lower than 1.0 mg/cm³ in the case that the glass substrate is immersed into a 10% HF solution for twenty minutes under a 22° C. environment temperature. In addition, in the case that the glass substrate is immersed into a 5% NaOH solution for 360 minutes under a 95° C. environment temperature, the weight loss of the glass substrate can be reduced to be less than 1.0 mg/cm³.

Therefore, the glass substrate compositions of this invention comprise SiO₂, Al₂O₃, B₂O₃, CaO, SrO, and a composition for forming the network structure of SiO₂ selected from the group of Y₂O₃ and La₂O₃. These compositions by assigned predetermined weight percentages can thus achieve a highly Young's modulus, a lower coefficient of thermal expansion, stronger chemical resistance, a higher strain point temperature and a higher annealing point temperature. Moreover, this invention can increase the production efficiency of the glass substrate and save the procedure time.

### BRIEF DESCRIPTION OF THE APPENDED DRAWINGS

The advantages and spirits of the invention may be understood by the following recitations together with the appended drawing.

FIG. 1 shows a list of preferred compositions of the glass substrate in accordance with the present invention.

### DETAILED DESCRIPTION OF THE INVENTION

The present invention refers to a plurality of compositions of a glass substrate. These compositions comprises SiO₂, Al₂O₃, B₂O₃, CaO, SrO, and a composition for forming a network structure of SiO₂, in which the composition for forming the network structure of SiO₂ can be selected from a group of Y₂O₃ and La₂O₃.

The glass substrate of this invention is a highly rigidity non-alkali glass substrate used for plate panel display. There are several producing procedure for glass substrate production, including an over-flow fusion process, a floating/Tin bath process, and a slit-down draw process. Also, the glass substrate used for the plate panel display is one of precision products whose surface roughness must be lower than 0.5 nm so as to display a satisfied image.

In the present invention, , the weight percentage of SiO₂ in the glass substrate is preferably ranged from 55% to 70%, such that the weight and the thermal expansion of the glass can be reduced to an acceptable extent. Yet, as a trade-off, the hike in energy cost and the decrease in production yield will seem to be inevitable while the producing temperature is raised and the production time is prolonged. Nevertheless, on the other hand, in the case that the weight percentage of SiO₂ in the glass is less than the above, devitrification may become a problem to reduce transparency of the glass, and also the chemical resistance may be decreased.

In the present invention, the weight percentage of the compositions comprising Y₂O₃ or La₂O₃ for forming network structure of SiO₂ in the glass is preferably ranged from 0.01% to 10%. By providing either Y₂O₃ or La₂O₃ as a medium oxide for forming network structure of SiO₂ in the glass substrate, the Young's modulus and the rigidity of the glass substrate can be substantially raised.

In the present invention, the weight percentage of Al₂O₃ in the glass is preferably ranged from 10% to 18%. Such an amount of the Al₂O₃ will be sufficient to reduce the liquid temperature of the glass.

In the present invention, the weight percentage of B₂O₃ in the glass is preferably ranged from 10% to 15%, so that the viscosity of melted glass can be reduced to ease the production of the glass substrate. However, it shall also be noted that too much B₂O₃ will reduce the chemical resistance of the glass.

In the present invention, the weight percentage of CaO in the glass is preferably ranged from 0% to 10%, And the weight percentage of SrO in the glass can be ranged from 0% to 4%. By providing the alkaline-earth metal as CaO or SrO to the glass, a plurality of positive ions can be induced to promote the producing process of the melting glass. Whereas, too many positive ions may cause the thermal expansion coefficient of the glass substrate to exceed a normal range. On the other hand, if the alkaline-earth metal is less used, more B₂O₃ needs to be added so as to keep the low viscosity of the melted glass.

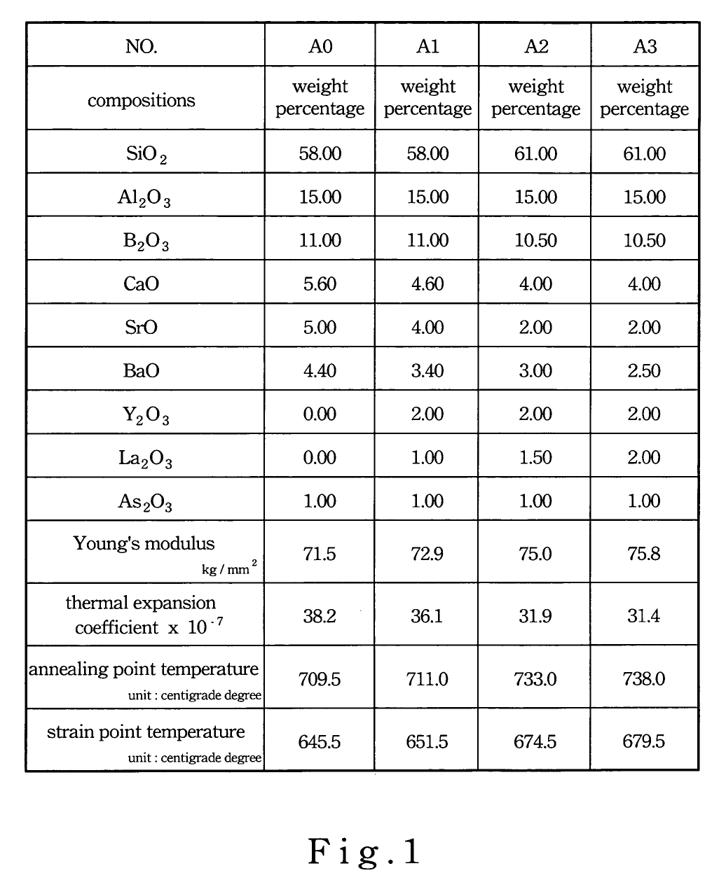

Referring to FIG. 1, a list concerning these compositions of the glass substrate in accordance with the present invention is shown to have four sets of compositions, labeled respectively as A0, A1, A2, and A3. In particular, A0 is the only set that does not have Y₂O₃. It is noted that both Young's modulus and the strain point temperature of A0 do not meet the requirement of a qualified glass substrate of this invention, while the other sets, A1, A2 and A3, can meet the requirement as the glass substrate of this invention.

In summary, the preferred compositions of this invention for the glass substrate can be 55% to 70% SiO₂, 10% to 18% Al₂O₃, 10% to 15% B₂O₃, 0% to 10% CaO, 0% to 4% SrO, and 0.01% to 10% the composition for forming the network structure of SiO₂ which can be selected from a group consisting of Y₂O₃, and La₂O₃.

Referring again to FIG. 1, it is noted that the Young's modulus of the glass substrate according to this invention is greater than 7200 kg/mm , the strain point temperature is higher than 650° C., the annealing point temperature is higher than 700° C., and the linear expansion coefficient is lower to 31×10⁻⁷.

Concerning the chemical resistance, the weight loss of the glass substrate of the present invention is lower than 1.0 mg/cm³ when it is immersed into a 10% HF solution for twenty minutes at about 22° C. Also, the weight loss of the glass substrate of the present invention is lower than 1.0 mg/cm³ while it is immersed into a 5% NaOH solution for 360 minutes at 95° C.

While in manufacturing the glass substrate with the compositions mentioned above in accordance with the present invention, some refining agents can be added to avoid bubbles in the glass. The refining agent can be selected from a group consisting of As₂O₃ with a weight percentage (wt %) from 0% to 1%, Sb₂O₃ from 0 wt % to 1 wt %, Ba(NO₃)₂ from 0 wt % to 1 wt %, and any mixture of the above.

Therefore, the compositions for the glass substrate of this invention comprises SiO₂, Al₂O₃, B₂O₃, CaO, SrO, and a composition for forming the network structure of SiO₂ that are selected from the group consisting of Y₂O₃, and La₂O₃. These compositions with predetermined weight percentage ranges can successfully make the glass substrate with a highly Young's modulus, a lower coefficient of thermal expansion, stronger chemical resistance, a higher strain point temperature and an annealing point temperature. Moreover, such compositions to the glass substrate of this invention can increase the production efficiency and save the production time. More particularly, production of large-area plate glass substrates with highly Young's modulus can be made easier.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. Compositions of a glass substrate, comprising:
SiO₂, at a weight percentage (wt %) from 55% to 70%; and
a composition for forming a network structure of SiO₂ selected from a group of Y₂O₃ and La₂O₃, at a weight percentage from 0.01% to 10%.

2. The compositions according to claim 1, further comprising:
Al₂O₃, at a weight percentage from 10% to 18%;
B₂O₃, at a weight percentage from 10% to 15%;
CaO, at a weight percentage from 0% to 10%; and
SrO, at a weight percentage from 0% to 4%.

3. The compositions according to claim 1, wherein said glass substrate has a Young's modulus greater than 7200 kg/mm

4. The compositions according to claim 1, wherein said glass substrate has a strain point temperature greater than 650 degree centigrade(° C.).

5. The compositions according to claim 1, wherein said glass substrate has an annealing point temperature greater than 700 degree centigrade.

6. The compositions according to claim 1, wherein said glass substrate has a linear expansion coefficien lower to 31×10⁻⁷.

7. The compositions according to claim 1, wherein said glass substrate has a weight loss lower than 1.0 mg/cm³ when said glass substrate is immersed into a 10% HF solution for 20 minutes at 22 degree centigrade.

8. The compositions according to claim 1, wherein said glass substrate has a weight loss lower than 1.0 mg/cm³ when said glass substrate is immersed into a 5% NaOH solution for three hundred sixty minutes under an environment temperature of 95 degree centigrade.

9. The compositions according to claim 1, wherein said glass substrate has a refining agent added to avoid bubbles while in forming said glass substrate, in which the refining agent is selected from a group consisting of As₂O₃ with a weight percentage from 0% to 1%, Sb₂O₃ with a weight percentage from 0% to 1%, and Ba(NO₃)₂ with a weight percentage from 0% to 1%.

10. The compositions according to claim 1, wherein said glass substrate is a non-alkali glass substrate used in a plate panel display and has a surface roughness smaller than 0.5 nm.
